(19) United States
(12) Patent Application Publication
(10) Pub. No.: US 2007/0137926 A1
(43) Pub. Date: Jun. 21, 2007

(54) Acoustical component for enhancing sound absorption properties while preserving barrier performance in a vehicle interior

(75) Inventors: Donald C. Albin JR., Carlisle, PA (US); David Boyles, Carlisle, PA (US)

Correspondence Address: MACMILLAN, SOBANSKI & TODD, LLC, ONE MARITIME PLAZA-FIFTH FLOOR, 720 WATER STREET, TOLEDO, OH, 43604, US

(73) Assignee: Lear Corporation

(21) Appl. No.: 11/304,380

(22) Filed: Dec. 15, 2005

(51) Int. Cl. E04B 1/82; F02B 77/13

(52) U.S. Cl. 181/290; 181/204

(57) ABSTRACT

The present invention is directed towards an acoustical component for vehicle interior that meets the foregoing needs. The component comprises an air impermeable inner covering layer having a sound reflective surface and one or more perforations therein. The perforations permit the passage of sound therethrough. An outer sound absorbing layer is bonded to the inner covering layer for absorbing the sound passing through the perforations in the inner covering layer.

### BACKGROUND OF INVENTION

The present invention relates to a component and method for absorbing noise in a vehicle interior, including the main cabin and trunk, and, in particular, to providing a sheet material with perforations optimized to facilitate noise absorption over a given range of frequencies.

Noise in the interior of a vehicle is undesirable, and its reduction or elimination has long been a goal of vehicle interior designers. A variety of components and methods exist to try to achieve this goal. Since it is well known that porous materials are generally good absorbers of sound, vehicle interior components are often covered with porous materials to help quiet the vehicle's interior. Carpeting is used on the floor and headliners are installed on the roof. Typically, thick porous materials faced with an open weave absorb sound better than thinner materials with impermeable faces. Often however, it is impractical to use thick materials in the interior of a vehicle, since interior space is limited. Moreover, a material with an open weave may lack other important functional characteristics such as high wear resistance. Hence, using thick, loosely woven carpets and headliners with open faces is not an adequate solution to the problem of vehicle interior noise.

The conventional method of quieting a vehicle cabin is to employ sound barriers. These barriers consist of an impermeable covering over top of a padding material. Floor systems, dash insulators, and trunk trim are good examples, as they are generally produced with a filled, extruded covering layer. Note that the floor system includes an “A” surface (i.e., carpet) that is placed over the covering layer. Interior trim, such as instrument panels and door panels, also consist of an impermeable covering, but in this case the coverings are generally injection molded plastics.

Exposed porous materials are generally not used for automotive interior applications. Areas where porous materials are exposed are limited to headliners, seats and seatbacks. These would apply to the discussion above.

The problem with standard porous materials, acoustically, is that they only absorb sound well at high frequencies. They do not absorb sound well at mid and low frequencies. Using these exclusively would result in a noisier vehicle because the mid and low frequency noise would not be adequately eliminated.

Accordingly, it is desirable to provide a component for enhancing sound absorption properties while preserving barrier performance in a vehicle interior and a method for tuning acoustical absorption in a vehicle interior to overcome the shortcomings of the prior art, by taking advantage of the large surface area within the vehicle interior to reduce noise from various sources while not using bulky and potentially expensive materials.

### SUMMARY OF INVENTION

The present invention is directed towards an acoustical component for vehicle interior that meets the foregoing needs. The component comprises an air impermeable inner covering layer having a sound reflective surface and one or more perforations therein. The perforations permit the passage of sound therethrough. An outer sound absorbing layer is bonded to the inner covering layer for absorbing the sound passing through the perforations in the inner covering layer.

Various objects and advantages of this invention will become apparent to those skilled in the art from the following detailed description of the preferred embodiment, when read in light of the accompanying drawings.

### BRIEF DESCRIPTION OF DRAWINGS

FIG. 1 is a sectional view of a component according to an embodiment of the invention;

FIG. 2 is a sectional view of a component according to another embodiment of the invention;

FIG. 3 is a sectional view of a component according to another embodiment of the invention;

FIG. 4 is a schematic illustration of the component shown in FIG. 2 in use;

FIGS. 5A-5F are enlarged scale views of perforation patterns according to various embodiments of the invention;

FIG. 6 is a line graph illustrating a relationship between frequency range and absorption coefficient for various perforation patterns; and

FIG. 7 is a flow chart illustrating steps in accordance with a method according to one embodiment of the invention.

### DETAILED DESCRIPTION

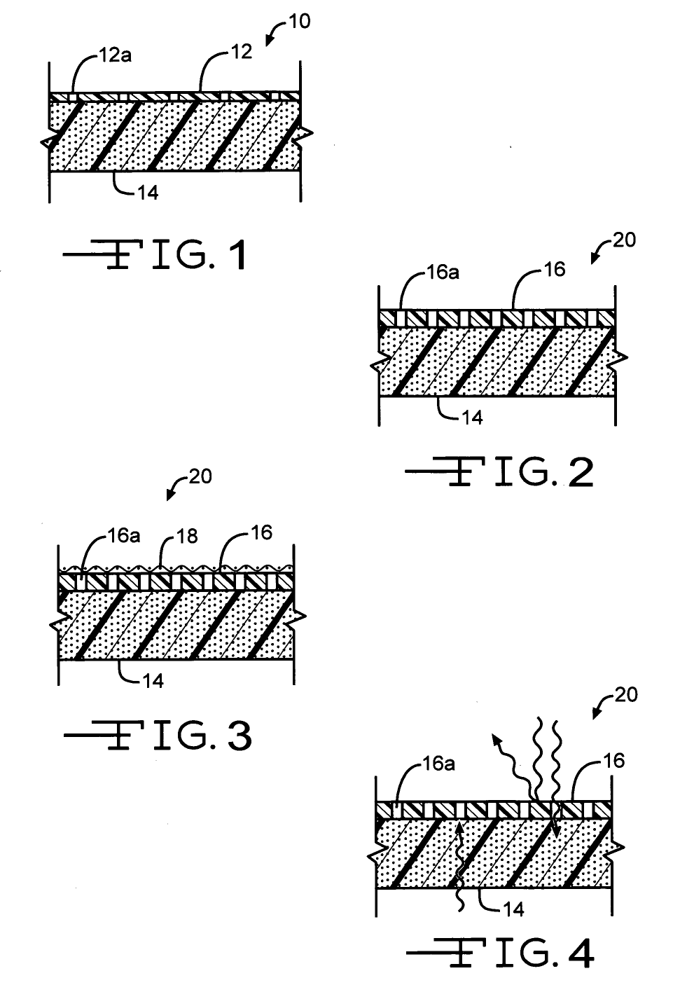

Referring now to the drawings, there is illustrated in FIG. 1 a cross-section of a composite or laminate component 10 for enhancing sound absorption properties while preserving barrier performance in a vehicle interior. The component 10 preferably comprises a perforated deformable inner covering layer 12 and an outer sound absorbing layer, such as the substrate sound absorbing layer 14. The covering layer 12 is perforated with a pattern of perforation that is preferably distributed generally uniformly throughout the covering layer 12.

The covering layer 12 is preferably monolithic water impenetrable or air impermeable covering layer 12 formed from plastic material because of its adhesion properties to the sound absorbing layer 14. The particular plastic composition may vary, depending upon commercial availability and structural integrity for the intended use. By way of example, nylon, polypropylene, polyester, ethylene vinyl acetate and polyvinyl chloride have been found to be satisfactory for some uses.

The covering layer 12 material preferably includes any of the well known thermoplastic and thermoset covering layer 12 forming materials that can be mechanically and/or thermally deformed. Examples of suitable thermoplastic covering layer 12 materials are natural substances such as crude rubber and synthetic materials such as polyvinyl chloride, nylons, linear polyethylene, polyurethanes, polypropylene, ethylene acrylic acid, ethylene vinyl acetate and acrylics. Thermoset materials undergo some softening under mild heating prior to final thermosetting or rigidification (usually caused by cross-linking) and are therefore suitable. Preferred covering layer 12 materials are polyesters, polyethylene, polyvinyl chloride, polypropylene, polyurethane, nylon, ethylene acrylic acid, ethylene vinyl acetate and similar materials.

The covering layer 12 preferably ranges in thickness from 0.0002 inch to 0.125 inch, preferably less than 1 mm.

The covering layer 12 may be in the form of an extrudate 16, which is illustrated in FIG. 2. The extrudate 16 is preferably a homogenous mixture of polymer, such as polyvinyl chloride, polypropylene or the like, and an inert particulate or fibrous filler, such as carbon black, calcium carbonate, limestone or other filler compatible with polymer, to add mass and density. Other suitable materials that may be used include ethylene vinyl acetate, urethane and polypropylene. These materials provide adequate stiffness and may be formed either by molding or by thermoforming. It is preferable that the extrudate 16 be kept thin in order to reduce its weight although it preferably has sufficient thickness to hold its shape. A thickness range of 0.003 inch to 0.125 inch is suitable for an extrudate covering layer 16. The extrudate covering layer 16 may, for example, have a density of about 0.7 grams per cubic centimeter to about 3.0 grams per cubic centimeter, 2.3 grams per cubic centimeter being preferred, although the present invention is not intended to be limited by this range of densities. Ethylene vinyl acetate (EVA) has also been found to be suitable composition for an extrudate covering layer 16 according to the invention. Extrudate 16 covering layers 12 have improved sound reflective characteristics, due at least in part to the increased mass and density of the extrudate 16 material.

The extrudate referred to above is generally filled with a mineral, such as carbon black, calcium carbonate, or barium sulfate. Mineral fillers add mass to the covering layer 16. The added mass and increased surface density improves the transmission loss performance of the composite or laminate component 10, thus improving its barrier performance.

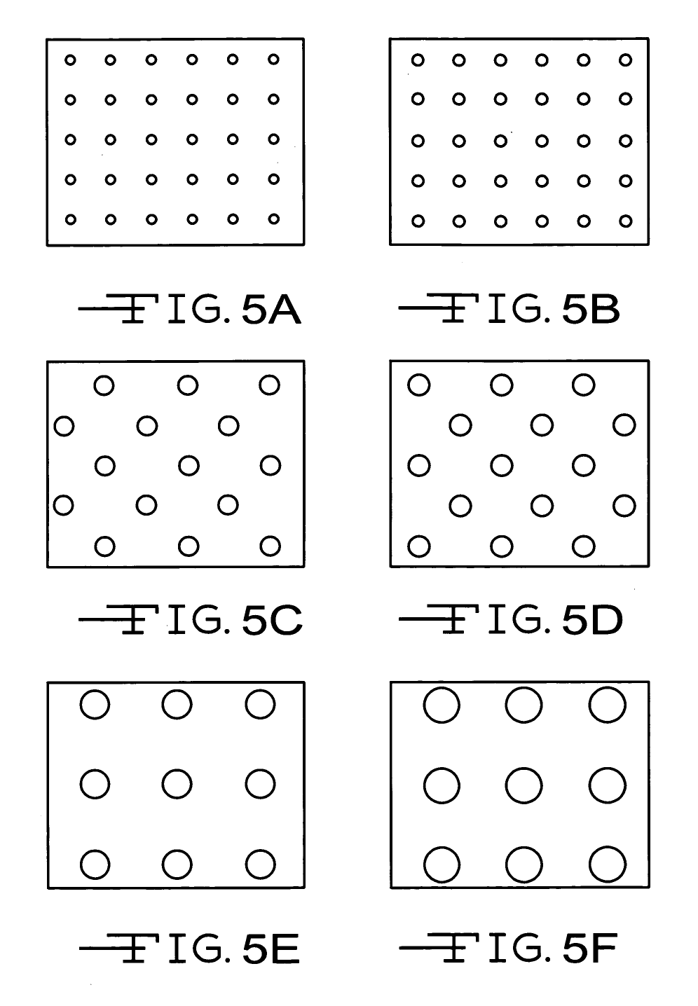

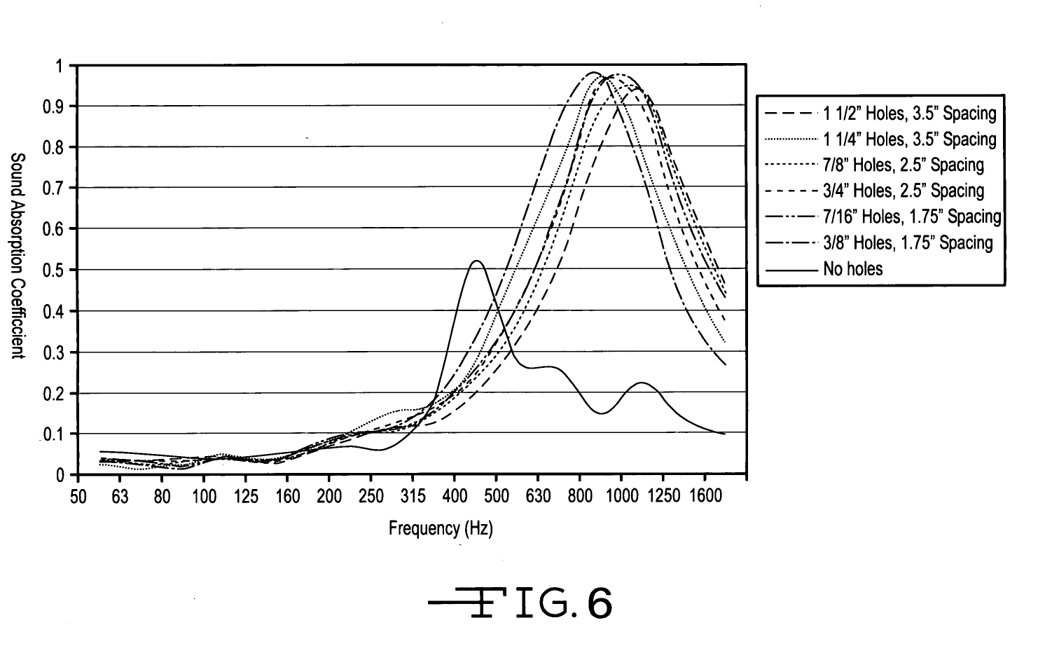

Examples of covering layers 12 or extrudates 16 according to the invention are illustrated in FIGS. 5A-5B. In these examples, perforations 12a, 16a of various sizes and spacings are formed in the covering layer 12. The perforations 12a, 16a are preferably formed prior to laminating the covering layer 12 to the sound absorbing layer 14, which will be described in detail below. The perforations 12a, 16a are uniformly spaced, relatively large perforations 12a, 16a that are located in predetermined areas. Larger perforations 12a, 16a are less likely to be filled during adhesion processes, which are describe below. The perforations 12a, 16a are preferably round, as shown in FIGS. 5A-5F, having diameters ranging from 0.031 inch to 1.5 inch, and a spacing ranging from 0.25 inch to 23 inches, although the perforations 12a, 16a may be any cross-section configuration.

By example, FIG. 5A is a reduced scale view of a perforation pattern having about 0.375 inch diameter perforation spaced about 1.75 inches apart to the centers of adjacent perforations 12a, 16a. FIG. 5B is a reduced scale view of a perforation pattern having about 0.438 inch diameter perforation spaced about 1.75 inches apart to the centers of adjacent perforations 12a, 16a. FIG. 5C is a reduced scale view of a perforation pattern having about 0.75 inch diameter perforation spaced about 2.5 inches apart to the centers of adjacent perforations 12a, 16a. FIG. 5D is a reduced scale view of a perforation pattern having about 0.875 inch diameter perforation spaced about 2.5 inches apart to the centers of adjacent perforations 12a, 16a. FIG. 5E is a reduced scale view of a perforation pattern having about 1.25 inch diameter perforation spaced about 3.5 inches apart to the centers of adjacent perforations 12a, 16a. FIG. 5F is a reduced scale view of a perforation pattern having about 1.5 inch diameter perforation spaced about 3.5 inches apart to the centers of adjacent perforations 12a, 16a.

While the illustrated perforation patterns include perforations 12a, 16a that are uniformly distributed throughout the entire surface of the covering layer 12 to improve the acoustical insulation of the component 10, it should be understood that the present invention may be practiced with perforation patterns that include perforations 12a, 16a that are randomly distributed and that do not cover the entire surface of the covering layer 12.

The sound absorbing layer 14 primary provides sound insulation, and is preferably a relatively soft, flexible material which is commercially available and suitable for installation within a vehicle. Various types of foam and fibrous materials are available. The particular material selected is within the discretion of a designer.

The sound absorbing layer 14 may or may not be formed of formable material, but is preferably formed of material which will substantially conform to and stretch around the shaped contours formed from a flat lamination to a component 10 configuration shaped as desired. The shaping should not be overly thin any particular area but rather should give or move sufficiently to keep it at a relatively uniform thickness, although some thinning may be inevitable at stretch points.

The sound absorbing layer 14 should be permeable to air and is preferably an acoustical open-celled foam, such as polyurethane foam. Other examples of suitable materials for the sound absorbing layer 14 include shoddy padding, which is a fibrous non-woven material, Marabond (a registered trademark of Janesville-Sackner, in Norwalk, Ohio), which is a moldable fibrous underpadding, or Corweb II, a product of Lear Corporation, in Southfield, Mich., and which is also a moldable fibrous underpadding that is described in U.S. Pat. No. 6,534,145, the description of which is incorporated herein by reference, or a number of other materials. It is preferably formed to approximately the same length and width dimensions as the covering layer 12, or to slightly lesser dimensions to facilitate installation of the component 10 in the vehicle, and is sufficiently flexible to follow the contour of the vehicle structure when in use.

Any flexible open cell foam material may be employed in practicing this invention and preferably can be adhesively activated upon exposure to heat, including both foam type thermoplastic resins, foam type thermosetting resins, and foam type elastomers. Many different types of flexible open cell foams having acoustical properties are known and the selection of any particular one is not critical to the practice of this invention and well within the abilities of those possessing ordinary skill in the foam art.

The thickness, density, cell pore size and degree of cell openness of the foam are capable of wide variations with the selection of specific values for these parameters being dictated by the desired end use of the product with specific emphasis upon the acoustical properties desired.

The covering layer 12 may be applied to the sound absorbing layer 14 in any suitable manner, such as by using suitable solvents or adhesives, such as a spray or web adhesive, which does not fill the perforations 12a, 16a, or a pressure sensitive adhesive, or mechanical fasteners, such as clip-on fasteners, for example, grommets, that do not require adhesives. The latter depends on the structure integrity of the component 10. Instead of utilizing a layer of adhesive to bond the covering layer 12 and sound absorbing layer 14 together, they may be bonded to one another in surface-to-surface contact without any intervening adhesive, as for example by flame or heat laminating, in which one of the contacting surfaces, such as the surface of the covering layer 12, is softened and rendered tacky by the application of heat from a torch, radiant energy emitter, or other heat source so that upon application to the sound absorbing layer 14, the contacting surfaces will weld or fuse together. In whatever manner the bonding takes place, the intention is to use commercially available equipment and techniques for simplicity and cost reduction. The use of larger perforations 12a, 16a in the covering layer 12 and the support provided by the sound absorbing layer 14 should maintain the shape and size of the perforations 12a, 16a, or prevent the perforations 12a, 16a from becoming larger in size, when the surfaces are bonded together.

As shown in FIG. 3, the covering layer 12 may optionally be covered with facing layer 18 that is typically an air permeable passing. The facing layer 18 may conceal the perforations 12a, 16a from view and function as a decorative cover to give the component 10 a rich texture or feel, or provide an appearance that is to aesthetically pleasing, and enhanced the sound absorption of the component 10, particularly when the component 10 is use in the interior of a vehicle. The facing layer 18 is preferably a stretchable material so that, when it is applied flat to the covering layer 12, it will deform and conform to contours as desired, although other materials may be suitable for carrying out the invention. One suitable form of such material is a commercially available two-way or four-way stretch-type nylon cloth which is formed of stretchable nylon threads that are knitted together into a stretch resulting sheet. Other woven types of materials that are stretchable would suffice likewise. Thus, a stretchable material is desirable, although the particular technique utilized for forming the material is not significant. That is, the material referred to here may be woven or knit, so long as it is air permeable. Other material may be used, including but not limited to needled or non-woven fabrics, or flocking, which are fibers directly adhered to the surface of the surface of the covering layer 12, as long as the fibers do not plug the perforations 12a, 16a. The facing layer 18 may alternatively be in the form of a material, such as a thin flexible vinyl skin, that is perforated with numerous small perforations 12a, 16a that align with the larger perforation in the covering layer 12. As yet another alternative, the facing layer 18 may be in the form of carpet, preferably a tufted or non-woven carpet.

In accordance with a preferred embodiment of the invention, the facing layer 18 is a tufted or non-woven carpet. These can be heated (e.g., using a radiant energy emitter or conduction heat or convection heat) and stretched into shape. They thereby retain their shape and add to the rigidity of the finished part.

Textiles, such as woven or knit fabrics (or even the stretch nylon described above) could also be used. Perforated leather or vinyl could also be used. The perforation diameter of the leather or vinyl facing layer 18 would preferably be much smaller and the spacing would preferably be much closer than the larger perforations (i.e., the macroperforations 12a, 16a) of the invention. Because of this, the perforations in the leather or vinyl facing layer 18 do not need to be aligned with the macroperforations 12a, 16a.

The facing layer 18 will preferably have the same length and width dimensions as the covering layer 12 and will be secured to the side of the covering layer 12 opposite the sound absorbing layer 14. The facing layer 18 may be applied to the covering layer 12 in any suitable manner, such as by using suitable solvents or adhesives or a flame heater, as mentioned above. The two layers are preferably fused together in an intimate surface-to-surface contacting relation without any intervening adhesive material. For this purpose, flame or heat laminating by heating the surface of the covering layer 12 sufficiently to render it tacky and to fuse to the facing layer 18 upon contact, may be employed. An adhesive, such as described above, may however be used to adhere the facing layer 18 to the covering layer 12. However, an adhesive between these layers should be selected so as not to significantly detract from the air permeability of the component 10.

A method for forming the component 10 may be as follows. An outer surface of the covering layer 12 and the sound absorbing layer 14 may be brought together and laminated or bonded. Next, the facing layer 18 may be bonded to the inner surface of the covering layer 12. The covering layer 12 has preferably already been perforated as desired.

Normally, when placing a covering layer 12 surface in front of a good sound absorber, such as a flexible open cell foam material, the good sound absorbing properties of the open cell foam is significantly reduced. Providing perforations 12a, 16a modifies the sound absorption performance of the newly-formed composite component 10 (i.e., covering layer 12 and the absorber), giving the component 10 enhanced sound absorption at low and mid frequencies, while maintaining some of the barrier performance of an impermeable covering. As illustrated in FIG. 4, exterior sounds, for example sounds from a source not within the vehicle main cabin or passenger compartment, may be absorbed directly into the sound absorbing layer 14. The covering layer 12 may be tuned to permit certain frequency sounds to be reflected off the covering layer 12 and certain frequency sounds to pass through the perforation in the covering layer 12.

Optimizing the perforation size and arrangement is possible with knowledge of the relationships between perforation size, spacing between perforations 12a, 16a, and frequency range of absorbed sound. Optimizing the perforation size and arrangement may also be a measure of the surface area covered with perforations 12a, 16a divided by the total surface area of the piece of covering layer 12. Testing was performed over the range of perforation patterns shown in FIGS. 5A-5F. The results of the test are illustrated in FIG. 6. Although FIG. 6 illustrates test results for perforations 12a, 16a ranging in size from about 0.375 inch to about 1.5 inch, in practice, preferred size of perforations 12a, 16a is greater than about 0.031 inch. It is expected however, that some applications may require perforation sizes outside this range. An examination of the graph shown in FIG. 6 reveals a relationship between the perforation size and spacing and the range of frequencies with a high sound absorption coefficient. The graph illustrates that perforations 12a, 16a of varying size permit a corresponding penetration of the noise into the sound absorbing layer 14.

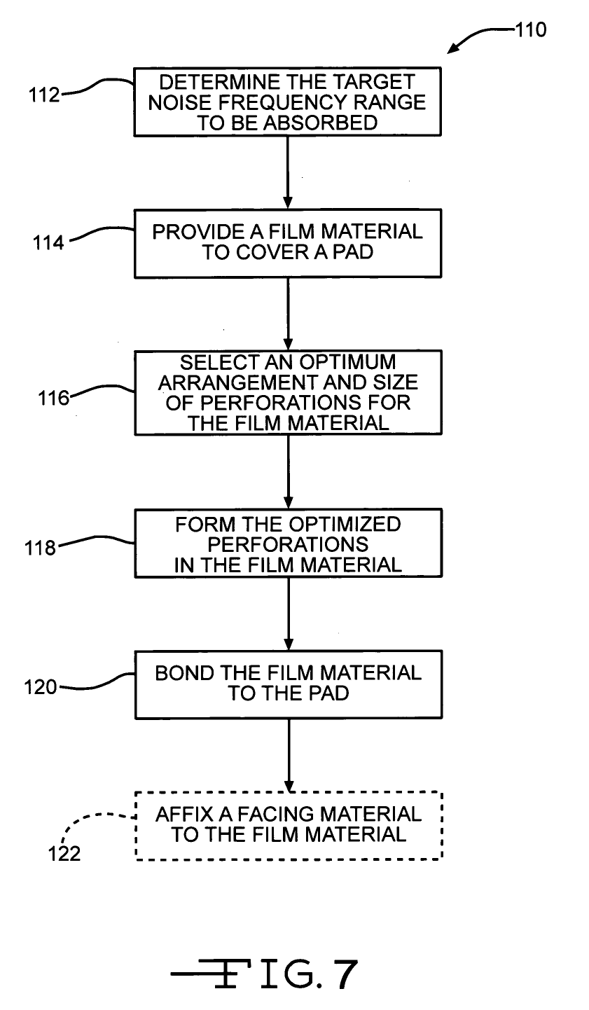

The steps involved in executing the preferred embodiment process are illustrated in the flow chart shown in FIG. 7. The process 110 includes five distinct steps. In the first step, which is represented in block 112, the target noise frequency range is determined. This is a useful step since different vehicle interiors have different noise frequencies. The target noise frequency range may be determined by performing a number of tests. For example, an engine may be first tested on a dynamometer to determine the frequency range of the engine noise. This is often referred to as determining the engine signature. In addition to engine dynamometer testing, the vehicle itself may be run on a chassis dynamometer. Conducting a chassis dynamometer test not only helps determine the engine signature, but also allows a variety of other vehicle noises to be measured. During the chassis dynamometer test, the vehicle can be run in a mode designed to generate high engine noise (e.g., in first gear only), or it may be run in a mode so that other vehicle noises predominate. Throughout the tests, the noise reaching the interior of the vehicle is measured. Next, road tests may be performed to provide information on road noise, wind noise, and the frequencies of other noises external to the vehicle. Other tests can be performed, tailored to the needs of particular vehicles.

Once the target frequency range is determined for a particular vehicle, a component 10 is provided for use in the vehicle, as represented in block 114. A choice is made for a covering layer 12 and a sound absorbing layer 14 to be covered by the covering layer 12. The covering layer 12 may be either a thin covering layer 12 or an extrudate 16, depending on its application and the desired affects. The sound absorbing layer 14 may be a foam or a fibrous material, depending on its applications.

The next step is to select an optimum size and spacing for the perforations 12a, 16a in the covering layer 12 or extrudate 16, as represented in block 116. The optimization of these parameters requires knowledge of the relationships between perforation size and spacing, and the frequency range of absorbed sound. Some of these relationships are illustrated graphically in FIG. 6. Once the optimum perforation size and spacing are chosen, the perforations 12a, 16a are formed in the covering layer 12 or extrudate 16. Finally, the perforated covering layer 12 is used to cover the sound absorbing layer 14 and an optional facing layer 18 may be used to cover the covering layer 12 and extrudate 16, opposite the sound absorbing layer 14. These last two steps are represented in FIG. 7 in blocks 118 and 120, respectively.

The bonding or assembly of the three layers (i.e., the facing layer 18, the covering layer 12 and the sound absorbing layer 14) is preferably accomplished in the flat state. Once the three layers are assembled into a composite or laminate form, the component 10 may be formed in any desired shape, for example, by means of suitable pressure and heat, of predetermined depths and lengths and widths. The component 10 may be formed in with a peripheral and surface contour as desired to sit over and cover an interior wall-like surface of the motor vehicle, or the structure to be lined, with the covering layer 12 facing layer 18 the vehicle interior toward the noise source within the vehicle. The component 10 may be formed in the shape of a headliner, which fits within the cab, operator compartment or passenger compartment of the vehicle, and covers the interior surface of the ceiling. Alternatively, it may be shaped as a door panel cover or insulation, or an interior cover for other portions of the vehicle, such as for the trim, the seats, the dash, the firewall, the floor, for example with tufted or non-woven carpet, the package shelf, or the like. Hence, the shape and size of the component 10 may vary depending upon the particular application. Various components, such as a floor component may overlap a dash component.

The component 10 may be shaped as follows. The component 10 may be placed within a suitable piece of forming equipment including, for example, a lower die and an upper die with appropriate cavities and shapes. Upon application of heat and pressure, as may be required, and utilizing conventional die or pressing techniques, the component 10 is shaped and depressed as required. Alternatively, a sag forming or vacuum forming process may be used. Because the facing layer 18 is air permeable and the covering layer 12 is perforated, vacuum forming is possible. Both of these processes are conventional.

The composite component 10 may be heated in multiple ways. For example, heat the facing layer 18, the covering layer 12, and sound absorbing layer 14 together in a contact heater, which includes two heated plates that contact both the facing layer 18 and the sound absorbing layer 14. By applying heat and pressure for a certain time, the entire composite component may be deemed formable.

Heat the facing layer 18, the covering layer 12, and sound absorbing layer 14 together in a convection or forced hot air heater, wherein heated air (either stagnant or blowing) warms the three layers 18, 12, 14.

In the case where an extrudate is employed, the facing layer 18 and the covering layer 16 may be heated separately from the sound absorbing layer 14. The facing layer 18 and the covering layer 16 are heated either in a contact heater, a convection or forced hot air heater, or under a radiant energy emitter. In the case of a radiant energy emitter, heat is transferred from a hot emitter to the surface of the covering layer 16 by the phenomenon of radiation. In this case, the sound absorbing layer 14 may be separately heated (through conduction or convection) and then brought together with the facing layer 18 and covering layer 16 before forming. Alternatively, the sound absorbing layer 14 may be pre-formed in the tool.

Basically, all three layers 12, 14, 18 may be heated by applying conduction (i.e. a contact heater), convection (i.e. a convection or forced hot air heater), or radiation (i.e. a radiant emitter) heat.

The shaped component 10 may be removed and positioned upon the interior surface where it is to be used. The component 10 is installed in the vehicle with the sound absorbing layer 14 facing the vehicle structure. The component 10 has been formed to the desired contour for installation and as before noted preferably has a substantial resistance to bending so as to hold its shape.

The component 10 may be applied against a supporting structure or support wall of the vehicle interior and may be secured thereto in any suitable manner, such as by mechanical fasteners, such as clips and grommets, or by use of hook-and-loop type fasteners, which permit application and removal of the component 10 when desired.

It should be noted that the perforations 12a, 16a according to the present invention do more than just allow sound to pass through at certain frequencies. They actually provide enhanced sound absorption properties to the composite component 10 (i.e., the covering layer 12, 16 and the sound absorbing layer 14). Sound absorption can be tuned to absorb much better at certain frequencies than the sound absorbing layer 14 alone. These frequencies are low to mid frequencies, between 400 hz and 3000 hz. Hence, the present invention is an enhancement to the sound absorption performance, not just a method of maintaining the existing performance of the padding.

The present invention also maintains a portion of the barrier performance of the composite component 10. Although the present invention creates a good sound absorber at low and mid frequencies, it also maintains some of the barrier performance, best measured via a sound transmission loss test. A barrier in this context reflects sound that is coming from the exterior of the vehicle.

The principle and mode of operation of this invention have been explained and illustrated in its preferred embodiment. However, it must be understood that this invention may be practiced otherwise than as specifically explained and illustrated without departing from its spirit or scope.

What is claimed is:

1. A vehicle interior acoustical component comprising:
an air impermeable inner covering layer having a sound reflective surface and one or more perforations therein, the perforations permitting the passage of sound therethrough; and
an outer sound absorbing layer attached to the inner covering layer for absorbing the sound passing through the perforations in the inner covering layer.

2. The component of claim 1 wherein the perforations are sized and arranged to permit only certain frequency sounds to pass therethrough.

3. The component of claim 1 wherein the perforations are greater than about 0.031 inch in cross-section.

4. The component of claim 1, wherein the perforations have a cross-sectional area ranging from about 0.375 inch to about 1.5 inches.

5. The component of claim 1, wherein the outer sound absorbing layer comprises open-celled foam.

6. The component of claim 1, wherein the outer sound absorbing layer comprises fibrous material.

7. The component of claim 1, wherein the inner covering layer and the outer sound absorbing layer are heat bonded together.

8. The component of claim 1, wherein the inner covering layer and the outer sound absorbing layer are bonded together by an adhesive.

9. The component of claim 1, further comprising an air permeable facing layer adjacent the inner covering layer.

10. The component of claim 9, wherein the facing layer comprises fabric.

11. The component of claim 9, wherein the facing layer comprises non-woven or tufted carpet.

12. The component of claim 1, wherein the inner covering layer and the outer sound absorbing layer cooperatively form a component.

13. A sound insulating sheet material comprising:
an air impermeable inner covering layer having a sound reflective surface and one or more perforations therethrough, the perforations permitting the passage of sound therethrough, the inner covering layer comprising a polymer and a filler; and
a outer sound absorbing layer adjacent the inner covering layer for absorbing the sound passing through the perforations in the inner covering layer.

14. The component of claim 13 wherein the polymer is a thermoplastic covering layer forming polymer.

15. The component of claim 13 wherein the polymer comprises one or more of a group consisting of polyethylene, polyurethane, polypropylene, polyvinyl chloride, or ethylene vinyl acetate.

16. The component of claim 13 wherein the filler comprises one or more particulate filler materials.

17. The component of claim 13 wherein the filler comprises one or more inert filler materials.

18. The component of claim 13 wherein the filler comprises one or more of a group consisting of carbon black, calcium carbonate, barium sulfate, talc, clay, mica, gypsum, fly ash or quartz.

19. The component of claim 13 wherein the inner covering layer and the outer sound absorbing layer are coupled together by one or more mechanical fasteners.

20. A vehicle comprising:
an interior surface; and
an acoustical component comprising:
an inner covering layer comprising air impermeable covering having a sound reflective surface and one or more perforations therethrough, the perforations permitting the passage of sound therethrough, the inner covering layer comprising a polymer and a filler;
a outer sound absorbing layer bonded to the inner covering layer for absorbing the sound passing through the perforations in the inner covering layer; and
an air permeable facing layer bonded to the inner covering layer opposite the outer sound absorbing layer, the acoustical component being shaped to conform to the shape of the interior surface and being support adjacent the interior surface.
